(19) United States
(12) Patent Application Publication
(10) Pub. No.: US 2017/0177696 A1
(43) Pub. Date: Jun. 22, 2017

(54) USAGE OF MODELED VALIDATIONS ON MOBILE DEVICES IN ONLINE AND OFFLINE SCENARIOS

(71) Applicant: SAP SE, Walldorf (DE)

(72) Inventors: Thomas Biesemann, Bruchsal (DE); Jens Kisker, Heidelberg (DE)

(21) Appl. No.: 14/976,545

(22) Filed: Dec. 21, 2015

(51) Int. Cl. G06F 17/30; G06F 11/14; H04L 7/00

(52) U.S. Cl. CPC G06F 17/30581; H04L 7/0008; G06F 11/1458; G06F 2201/84

(57) ABSTRACT

According to various embodiments, systems and methods for validating transactions on a client device when it is operating in an offline mode are presented. According to the disclosure, the client device may receive an initial data synchronization from a server to generate a local copy of data. Additionally, the client device may receive a validation model from the server based on a set of validation rules. The client device may receive an indication to update a local copy of the data while the client device is operating in an offline mode. The indicated update to the local copy may be validating using the validation model. If successfully validated, the local copy of the data may be updated. When the client device enters an online mode, the local copy of the data can be synchronized with the server.

### BACKGROUND

### Background

Database systems often receive data updates from client systems in the form of transactions. Before the database can be updated, the transactions must be validated to ensure that they comply with various rules of the database system. For instance, an example database rule might dictate that a particular column in a table is only populated with data of a certain type and any attempt to update data in that column with the wrong type could result in an error message. That error message can then be immediately forwarded to the client system and the transaction can be corrected so that it complies with the database rule. In this way, the validity of the data stored on the database can be ensured.

A problem can arise when client systems generate transactions while they are offline. When the client is offline, its transactions cannot be immediately validated and any errors resolved. Instead, the client system must wait until a synchronization to resolve any validation conflicts with the database system. This delayed resolution of validation conflicts is inefficient and can be difficult to implement.

### BRIEF DESCRIPTION OF THE DRAWINGS

The accompanying drawings are incorporated herein and form a part of the specification.

FIG. 1 is a block diagram of a client-server system according to various embodiments.

FIG. 2 is a block diagram of a client system according to various embodiments.

FIG. 3 is a sequence chart depicting data flow according to various embodiments.

FIG. 4 is a flow chart depicting a method of synchronization according to various embodiments.

FIG. 5 is a flowchart depicting aspects of a method of synchronization according to various embodiments.

FIG. 6 is a flowchart depicting aspects of another method of synchronization according to various embodiments.

FIG. 7 is a flowchart depicting aspects of another method of synchronization according to various embodiments.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for synchronizing transactions from a client device to a server.

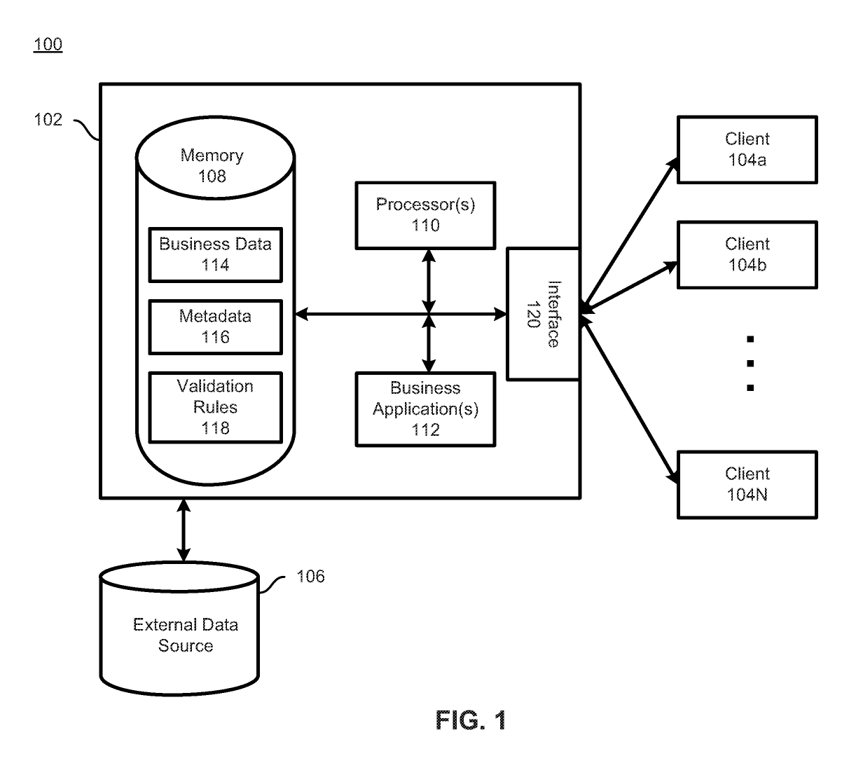

FIG. 1 depicts a client-server database system 100 according to various embodiments. The system includes a server 102 and a number of clients 104a, 104b, . . . 104N (collectively referred to herein as “clients 104.”) For convenience, only one database server 102 is depicted, but the system 100 could include any number of servers 102 and/or be implemented in a distributed fashion and still fall within the scope of this disclosure. Additionally, the server 102 may be communicatively coupled to an external data source 106.

The server 102 includes a memory 108, one or more processors 110, one or more business applications 112, and a network interface 120 that is configured to communicate with the clients 104. As shown, the memory 108 is configured to contain a number of different kinds of data including, but not limited to, business data 114, metadata 116, and validation rules 118. The business application 112 is configured to update, for example, the business data 114 and the metadata 116 according to the various validation rules 118.

In an embodiment, validation rules 118 ensure the consistency of data in system 108. Some of the validations may be based on business rules or conditions, which, when met, cause a validation error message to be produced so that a user of system 100 can resolve the violation. For instance, in a sales environment, the following might be validation rules and/or conditions:
If a product with a status of “not released” is used in a sales order, raise an appropriate error message;
If the customer of a sales order does not exist, raise an appropriate error message; and
If the amount of a sales order is negative, raise an appropriate error message.

As shown in FIG. 1, clients 104 can communicate with server 102 via network interface 120. For instance, a client 104 may communicate a transaction that would update either business data 114 or metadata 116 stored in the memory 108 of server 102. Upon receipt of the transaction from client 104 business application 112 could validate the transaction according to validation rules 118 in order to make sure the transaction does not run afoul of any of the rules. Validation may take the form of, for instance, comparing the validation rules to data stored in the memory or querying the external data source 106. If the validation is successful, then the business application 112 can update the appropriate data (114 or 116) based on the transaction. However, if the transaction would cause a validation error (i.e., satisfy one of the validation error rules 118 and/or conditions) one of the validation rules 118, the business application can send an error message or indication of a validation conflict to the client 104. The client can then resolve the conflict and send back the resolution.

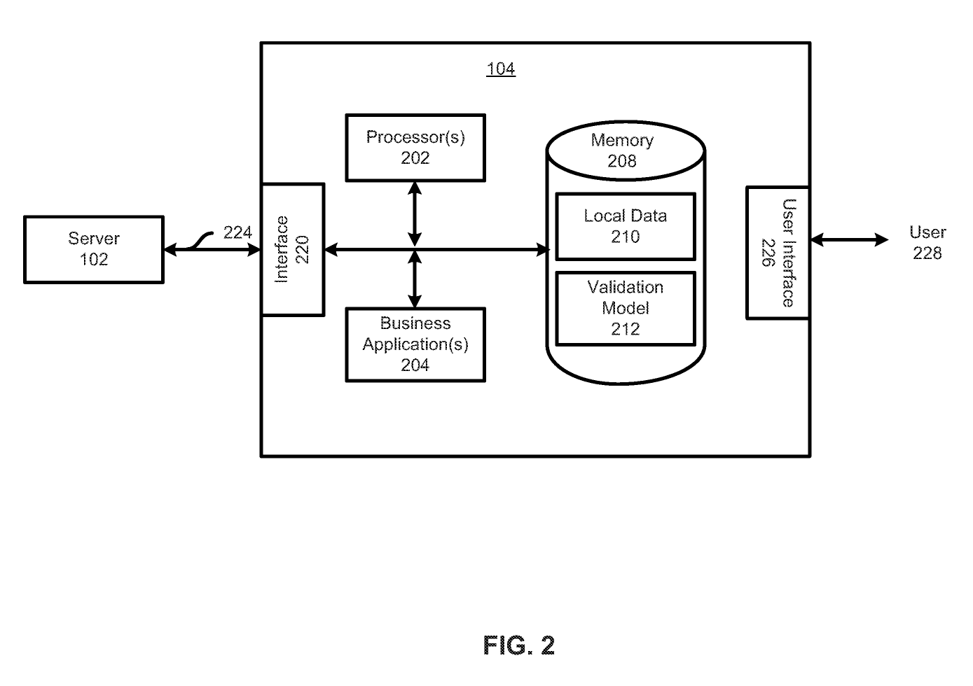

FIG. 2 is a functional block diagram depicting a client device 104 according to various embodiments. As shown, the client 104 includes one or more processors 202, its own business application 204, a local memory 208. The local memory 208 can store local data 210 and a validation model 212. The client device 104 also includes a network interface 220 for communicating with server 102 via network 224 and a user interface 226 for communicating with user 228.

According to embodiments, the client device 104 may be capable of operating in both an online mode and an offline mode. The client device 104 can operate in an online mode when the network connection 224 between server 102 and client device 104 is active. The client device can operate in the offline mode when the network connection 224 between server 102 and client device 104 is not active. By way of example, if client device 104 is a mobile device, client device 104 might operate in an online mode when it is in range of a suitable wireless network connection (e.g., connection 224) and operate in an offline mode when the client device is out of range of a suitable wireless network connection. According to some embodiments, the client device 104 may switch automatically between the online and offline modes depending on whether a suitable active network connection 224 is detected. However, it may also be possible to selectively toggle or command client device 104 between online and offline modes regardless of whether the client device 104 is connected to a suitable network connection 224.

As noted above, FIG. 2 shows that the local memory 208 of the client device 104 comprises local data 210. Local data 210 may include, for instance, business objects or other data for use by the business applications 204 that are run on client device 104. For instance, the local data 210 may include a subset of the business data 114 and metadata 116 stored on the server memory 108.

When operating in online mode, the client device 104 may rely on the business data 114, metadata 116, and/or validation rules 118 stored in memory 108 of the server 102 to validate transactions. When operating in the offline mode, the client device 104 may rely on the local data 210 and/or the validation model 212 to validate transactions made by a user 228 of the client device 104.

The validation model 212 consists of a set of declarative rules that model the validation rules relevant to the local data 210 and the local business applications 204. In an embodiment, the validation model can be implemented such that it is independent of the programming languages used by the server 102. For instance, the validation model 212 may be stored in a format that can be run while the client device 104 is operating in the offline mode such as in Extensible Markup Language (XML) or JavaScript Object Notation (JSON).

According to some embodiments, the local data 210 and the validation model 212 are only used when the client device 104 is operating in the offline mode. In such a scenario, the client device may perform a synchronization with the server 102 prior to entering the offline mode or as part of transitioning from online mode to offline mode. When the synchronization occurs, relevant business data 114 and metadata 116 is transferred from the server memory 108 to the local data store 210 in the memory 208 of the client device 104. The data transferred to the local data store 210 could, for instance, be data required by business applications 204 that are run on client device 104. Additionally, the server may provide the client device with the validation model 212 at the time of synchronization. Additionally, the client device 104 may periodically request an updated validation model 212 according to embodiments. According to some embodiments, the validation model may be pre-determined based on the set of validation rules 118. However, it is also possible for the server 102 to generate the validation model on demand when requested to do so by the client device 104.

In an embodiment, with the local data 210 synchronized to the server data 108 and the validation model provided by the server 102, the client device may operate in offline mode without the need for an active network connection 224.

In an embodiment, in order to ensure data integrity, the same validation logic may be used regardless of whether the client device 104 is operating in the online mode or the offline mode. That is, the validation model 212 may accurately reflect the logic of the validation rules 118. Consider, for instance, the following example. Consider a case where the following validation rule exists: “if the amount of a sales quote is greater than $10 K USD and a sales rep tries to close the sales quote, a filed ‘deal closed by’ is mandatory and has to be filled in by the user, otherwise an error message shall appear.” If, in this example, the validation rule were only available online, a sales rep using the client device 104 in the offline mode could close a sales quote without filling in the “deal closed by” field. In this case, once the client device 104 transitions into the online mode and tries to synchronize its data, there will be an error message stating that the changes cannot be saved due to the mandatory “deal closed by” field being unfilled. The sales rep would then have to manually resolve this conflict and try to synchronize the data again.

However, if the same validation logic were in place both online and offline, then the data would always be consistent and the number of synchronization conflicts and manual effort would be reduced.

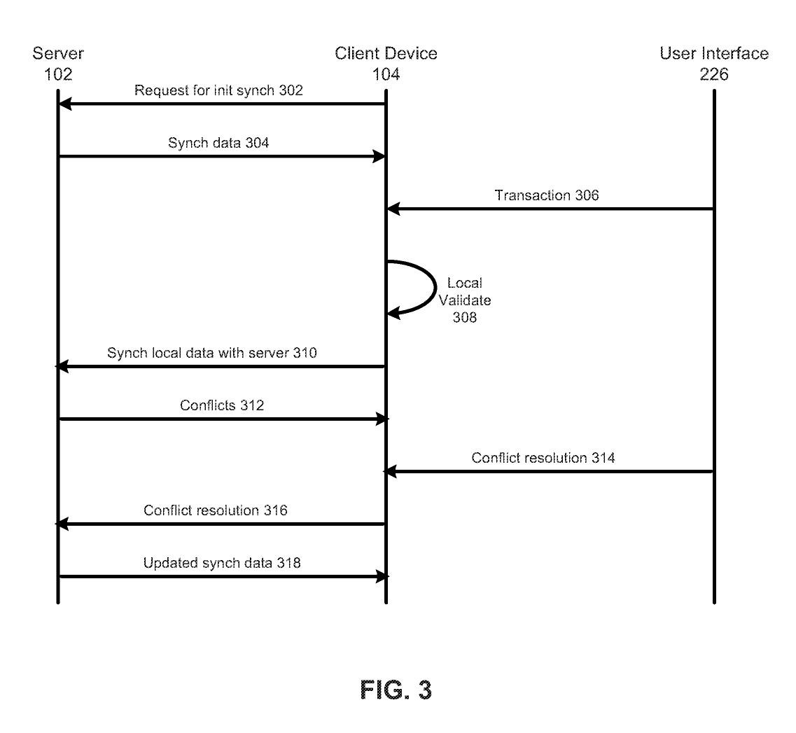

FIG. 3 is a sequence chart illustrating the message flow of system 100 according to various embodiments. For clarity and without limitation, FIG. 3 will be described with reference to FIGS. 1 and 2 as well. Assuming that the client device 104 begins in the online mode, client device 104 may determine that it will soon enter the offline mode and send a request for an initial synchronization 302. In response to the request for synchronization 302, the sever 102 may send back to the client device 104, synchronization data 304. The synchronization data 304 may include, for instance, a subset of the business data 114 and/or the metadata 116 to be stored as local data 210 on the client device 104. The synchronization data 304 may also include a validation model 212 based on the validation rules 118 stored on server 102. As discussed above, the validation model 212 should represent the same validation logic as the validation rules 118.

After receiving the synchronization data 304, the client device 104 may transition into the offline mode. While in the offline mode, client device 104 may receive a transaction 306 via user interface 226 from user 228. Since the client device 104 is in the offline mode at this point, it may validate the transaction 306 using the locally-stored validation model 212.

When client device 104 again transitions to online mode, client device 104 may send a synchronization message 310 to the server 102. The server 102 may then review any transactions made while the client device 104 was in the offline mode and determine whether there are any conflicts with the validation rules 118. If so, the server 102 can send a message 312 back to the client device 104 identifying the conflicts. A user then may input a resolution message 314 to the conflicts via user interface 226. A conflict resolution message 316 may then be sent from client device 104 to the server 102. The local data 104 may be then updated with an updated synchronization message 318.

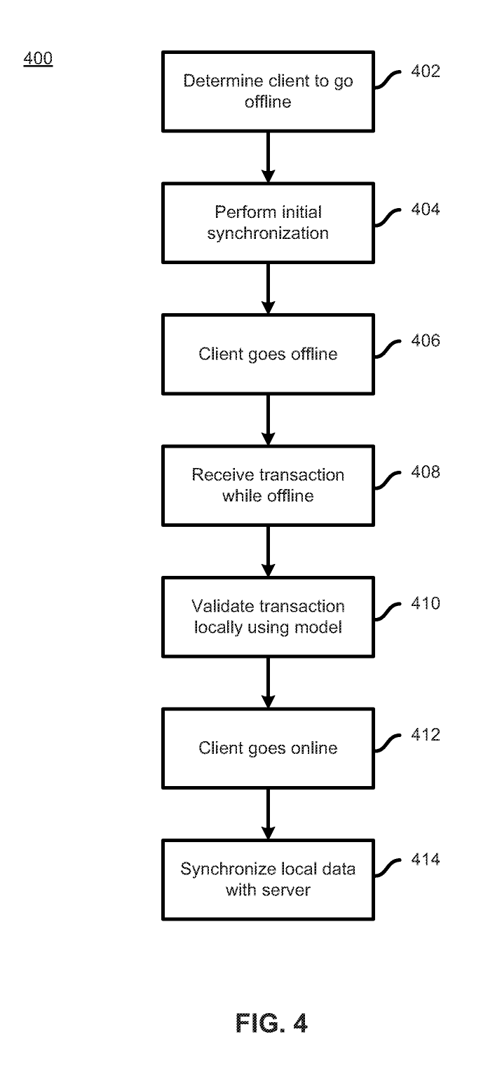

FIG. 4 is a flow chart depicting a method 400 for validating business logic when a client device is in an offline mode according to various embodiments. The method 400 begins at stage 402 when the client device 104 determines that it will enter an offline mode. After determining that it will enter an offline mode, the client device 104 performs an initial synchronization with the server 102. The initial synchronization may include copying a subset of business data 114 and/or metadata 116 stored on the memory 108 of the server to the local data 210 store on the local memory 208 of the client device 104. According to some embodiments, the data copied to the local data store 210 at stage 404 may include only data required by the business applications 204 running on client device 104.

The data synchronization stage 404 may also include transfer of a validation model 212 from server 102 to device 104 for storage in the local memory 208 of client device 104. The validation model may comprise a set of declarative rules stored in a format that can be interpreted by the client device and run in the offline mode without access to the server 102. As noted above, validation model 212 may be implemented in XML, or JSON according to various embodiments.

At stage 406, the client device 104 enters an offline mode. While in the offline mode, client device can receive a transaction at stage 408 via, for instance, the user interface 226. At stage 410, the client device 104, still in offline mode, can validate the transaction received at stage 408 using the validation model 212. If the transaction complies with the validation model 212, then the transaction can be logged in the memory 208 of the client device or the local data 210 updated as appropriate. If the validation using the validation model 212 is unsuccessful, then an error message can be sent to the user 228 via user interface 226 for resolution.

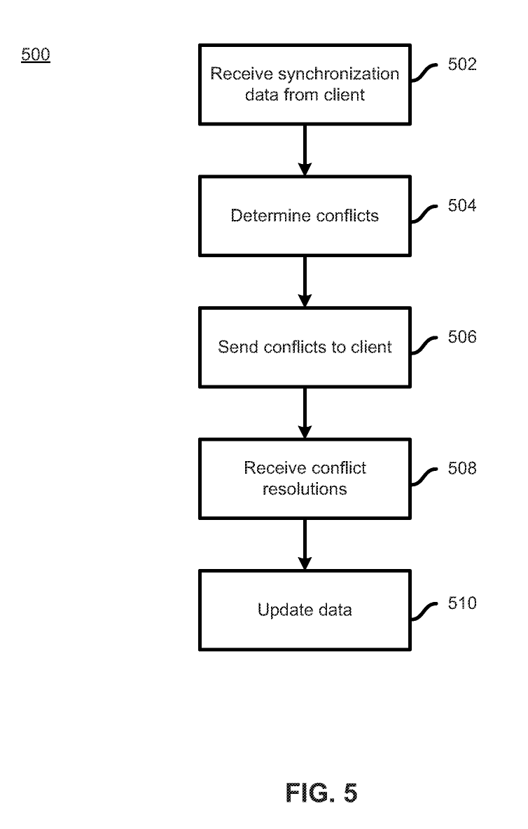

At stage 412, the client device 412 can enter the online mode again and the local data and transactions stored in the local memory 208 can be synchronized with the server 102 at stage 414. The details of the synchronization stage 414 are discussed with in greater detail with respect to FIG. 5 below.

FIG. 5 is a flowchart depicting a method 500 of synchronizing data from a client device 104 to a server 102 according to various embodiments. The method 500 begins at stage 502 when the server 102 receives synchronization data from a client device 104. This may happen, for instance, when the client device 104 enters an online mode after having been in an offline mode. The synchronization data may include updates to the local data 210 that occurred during the offline mode and/or logs of transactions that occurred during the offline mode.

At stage 504, the method determines whether any of the synchronization data from the client 102 results in any conflicts according to the validation rules 118. If not, then the method may skip directly to stage 510. However, if there are conflicts determined at stage 504, then those conflicts are sent to the client for resolution at stage 506. The client may then present the conflicts to a user 228 via user interface 226 and receive resolutions to the conflicts via the same user interface 226.

The resolutions to the conflicts are then received from the client device 104 by server 102 at stage 508. These can be optionally re-validated at stage 504 or the method 500 can proceed to stage 510 where the data (e.g., business data 114 and metadata 116) is updated according to the synchronization.

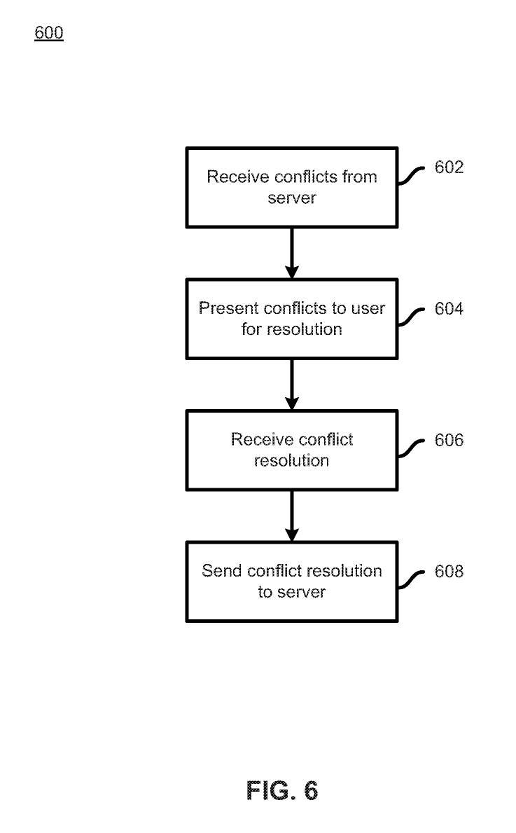

FIG. 6 is a flowchart depicting a method 600 of resolving conflicts at a client device 104 detected upon synchronization with a server 102 (e.g., at stage 414 of method 400) after the client device enters the online mode from the offline mode according to various embodiments. As shown in FIG. 6, the method 600 begins by receiving identified conflicts from the server 102 at the client device 104 at stage 602. These conflicts can then be presented to the user 228 for resolution via user interface 226 at stage 604.

At stage 606, the user 228 can provide the resolution to the identified conflict via user interface 226. For instance, accord to some embodiments, the user 228 may be presented with the opportunity to revise a field in a transaction causing the conflict to resolve the conflict. Additionally, the user, in some embodiments, may be asked to provide additional information in order to resolve the conflict. The resolution can then be sent from the client device 104 to the server 102 via network connection 224.

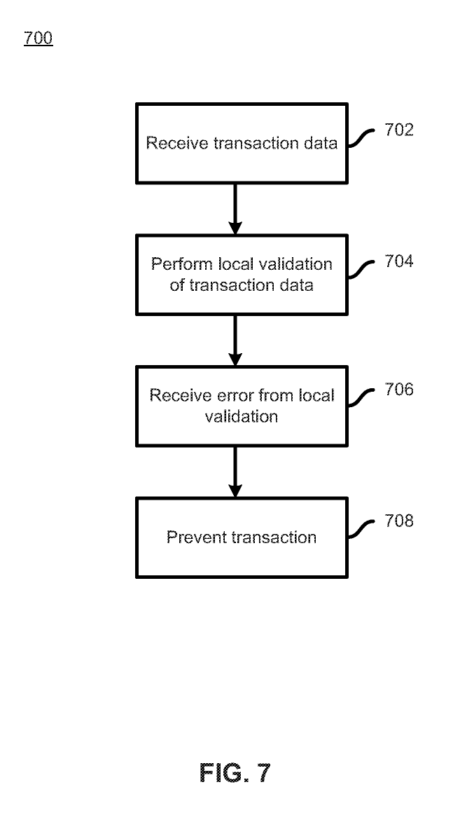

FIG. 7 is a flowchart depicting a method 700 of dealing with a transaction made with a client device 104 while the client device 104 is in an offline mode. According to the method 700, the client device 104 may receive transaction data 702 via, for instance, the user interface 226. At stage 704, the method 700 performs a local validation of the transaction data using the validation model 212 stored locally in the memory 208 of the client device 104. If the transaction data does not comply with the validation logic of the validation model 212, the client device 104 may generate an error message at stage 706. At stage 708, the transaction is not processed until the conflict is resolved. According to some embodiments, the user may be optionally be presented with an opportunity to resolve the conflict (as shown in FIG. 6 with respect to method 600), but this stage is not necessary in all embodiments.

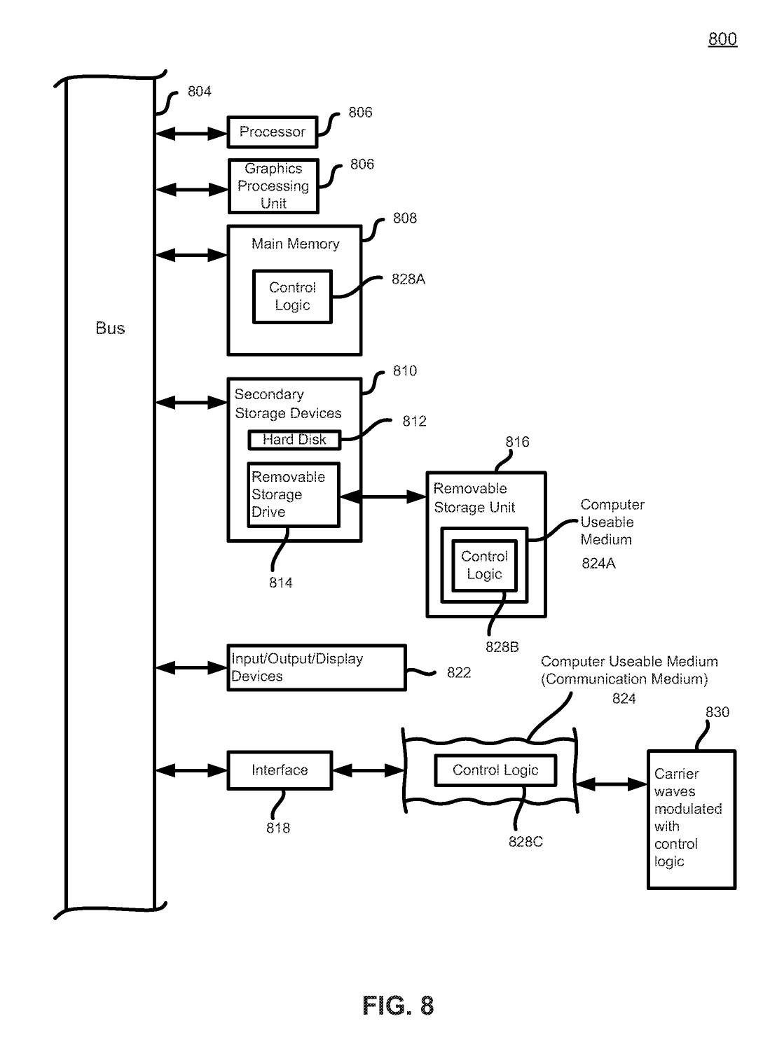

Various embodiments can be implemented, for example, using one or more well-known computer systems, such as computer system 800 shown in FIG. 8. For instance either of server 102 or client device 104 could be implemented as computer system 800 according to various embodiments. Computer system 800 can be any well-known computer capable of performing the functions described herein.

Computer system 800 includes one or more processors (also called central processing units, or CPUs), such as a processor 804. Processor 804 is connected to a communication infrastructure or bus 806.

One or more processors 804 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 also includes user input/output device(s) 803, such as monitors, keyboards, pointing devices, etc., that communicate with communication infrastructure 806 through user input/output interface(s) 802.

Computer system 800 also includes a main or primary memory 808, such as random access memory (RAM). Main memory 808 may include one or more levels of cache. Main memory 808 has stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/ any other computer data storage device. Removable storage drive 814 reads from and/or writes to removable storage unit 818 in a well-known manner.

According to an exemplary embodiment, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

In an embodiment, a tangible apparatus or article of manufacture comprising a tangible computer useable or readable medium having control logic (software) stored thereon is also referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use embodiments of the invention using data processing devices, computer systems and/or computer architectures other than that shown in FIG. 8. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, stages, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A method of validating transactions on a client device, comprising:
performing an initial data synchronization with a server to generate a local copy of data;
receiving an indication to update the local copy of the data while the client device is offline;
validating the indicated update to the local copy of data using a validation model;
updating the local copy of the data in response to a successful validation; and
synchronizing the local copy of data with the server.

2. The method of claim 1, wherein the validation model comprises a set of declarative rules.

3. The method of claim 2, wherein the declarative rules are independent of a backend environment of the server.

4. The method of claim 1, further comprising:
receiving the validation model from the server when the initial data synchronization is performed.

5. The method of claim 1, wherein synchronizing the local copy of the data with the server comprises:
identifying conflicts between the local copy of the data and a copy of the data on the server; and
manually resolving the identified conflicts.

6. The method of claim 1, wherein the initial data synchronization is performed in response to an indication that the client device will enter an offline mode.

7. The method of claim 1, wherein the synchronizing the local copy of data with the server is performed in response to an indication that the client device has entered an online mode.

8. The method of claim 1, further comprising sending a request for an updated validation model to the server.

9. The method of claim 8, wherein the request for an updated validation model is sent in response to an indication that the client device has entered an online mode.

10. The method of claim 1, further comprising:
preventing an update to the local copy of the data in response to an unsuccessful validation.

11. A client device, comprising:
a network interface;
a memory containing a plurality of computer instructions; and
one or more processors configured to execute the computer instructions and, in response, to:
perform an initial data synchronization over the network interface with a server to generate a local copy of data;
receive an indication to update the local copy of the data while the client device is offline;
validate the indicated update to the local copy of data using a validation model;
update the local copy of the data in response to a successful validation; and
synchronize the local copy of data with the server over the network interface.

12. The device of claim 11, wherein the validation model comprises a set of declarative rules.

13. The device of claim 12, wherein the declarative rules are independent of a backend environment of the server.

14. The device of claim 11, wherein the one or more processors are further configured to:
receive the validation model from the server, via the network interface, when the initial data synchronization is performed.

15. The device of claim 11, wherein the one or more processors are configured to synchronize the local copy of the data with the server by:
identifying conflicts between the local copy of the data and a copy of the data on the server; and
facilitate manual resolution of the identified conflicts.

16. The device of claim 11, wherein the one or more processors are configured to perform the initial data synchronization in response to an indication that the client device will enter an offline mode.

17. The device of claim 11, wherein the one or more processors are configured to synchronize the local copy of data with the server in response to an indication that the client device has entered an online mode.

18. The device of claim 11, wherein the one or more processors are further configured to send a request for an updated validation model to the server via the network interface.

19. The device of claim 18, wherein the one or more processor are configured to send a request for an updated validation model in response to an indication that the client device has entered an online mode.

20. A non-transitory computer readable medium containing computer instructions that, when executed by one or more processors, cause the one or more processors to perform steps comprising:
performing an initial data synchronization with a server to generate a local copy of data;
receiving an indication to update the local copy of the data while the client device is offline;
validating the indicated update to the local copy of data using a validation model;
updating the local copy of the data in response to a successful validation; and
synchronizing the local copy of data with the server.
